(19) United States
(12) Patent Application Publication
(10) Pub. No.: US 2026/0141691 A1
(43) Pub. Date: May 21, 2026

(54) METHOD, APPARATUS, AND COMPUTER PROGRAM FOR AUGMENTING SOILED DATA OF AUTONOMOUS DRIVING CAMERA SENSORS

(71) Applicant: CHUNGBUK NATIONAL UNIVERSITY INDUSTRY-ACADEMIC COOPERATION FOUNDATION, Cheongju-si (KR)

(72) Inventors: Jiwon HEO, Cheongju-si (KR); Taewoo KIM, Cheonan-si (KR); Youngbae Hwang, Cheongju-si (KR)

(73) Assignee: CHUNGBUK NATIONAL UNIVERSITY INDUSTRY-ACADEMIC COOPERATION FOUNDATION, Cheongju-si (KR)

(21) Appl. No.: 19/310,657

(22) Filed: Aug. 26, 2025

(30) Foreign Application Priority Data
Nov. 21, 2024 (KR) 10-2024-0167305
Feb. 21, 2025 (KR) 10-2025-0023114

(51) Int. Cl. G06V 10/774; G06N 3/0455; G06N 3/0475; G06T 5/50; G06T 5/77; G06T 7/11; G06V 10/764

(52) U.S. Cl. CPC G06V 10/774; G06N 3/0455; G06N 3/0475; G06T 5/50; G06T 5/77; G06T 7/11; G06V 10/764

(57) ABSTRACT

The present disclosure provides a method for augmenting soiled data of an autonomous driving camera sensor, including: receiving a clean image captured by an autonomous driving camera sensor and a soiled area designation image; generating a conditioned image by performing a synthesis operation on the clean image and the soiled area designation image; and generating a first sensor contamination image by inputting a text prompt specifying foreign matters and the conditioned image to a diffusion model.

### CROSS-REFERENCE TO RELATED APPLICATIONS

This application claims priority under 35 U.S.C. § 119 to Korean Patent Application No. 10-2025-0023114, filed on Feb. 21, 2025, and Korean Patent Application No. 10-2024-0167305, filed on Nov. 21, 2024, both filed in the Korean Intellectual Property Office, the disclosures of which are incorporated herein by reference in their entireties.

### TECHNICAL FIELD

The following disclosure relates to a method, apparatus, and computer program for augmenting soiled data of an autonomous driving camera sensor, and more particularly, to a method, apparatus, and computer program for augmenting soiled data of an autonomous driving camera sensor for training an artificial intelligence model to determine a contamination level of an autonomous driving camera sensor.

### BACKGROUND

Autonomous driving systems should overcome various challenges to reach full automation (SAE Level 5). Among these challenges, ensuring the reliability of sensors that directly interact with the external environment is regarded as a particularly important challenge. Wide-angle camera sensors used in the autonomous driving systems are installed at the front, sides, and rear of a vehicle and play a key role in recognizing the surrounding environment. However, there is a problem in that these camera sensors are exposed to the external environment and are easily contaminated by various foreign matters such as rain, snow, dust, and mud.

The contaminated camera sensor may seriously impede the normal operation of the autonomous driving system. When the sensor becomes contaminated with foreign matters, the sensor's ability to perceive the surrounding environment may deteriorate, and thus, may fail to properly detect potential hazardous situations, which significantly increases the likelihood of accidents. Therefore, to reach the full automation, technologies capable of accurately detecting and removing or compensating for camera sensor contamination are essential.

While numerous studies exist on detecting contaminants by the camera sensors, most of these studies struggle to improve performance due to the lack of data problem. In the autonomous driving environments, camera image data contaminated with foreign matters are rarely available, and even the publicly available datasets exhibit insufficient environmental diversity (weather conditions, time of day, road conditions, etc.). In addition, collecting pixel-level ground truth for tasks such as soiled segmentation is a tedious and time-consuming process.

In particular, due to the unclear boundaries of contamination categories and the ambiguous definitions of contamination classes depending on the data, it is difficult to classify contamination at a pixel level and substantial human resources are required. Foreign matters often have varying transparency and irregular patterns, and depending on the soiled degree, the distinction from the background is often ambiguous, making consistent labeling difficult. The difficulty of data collection leads to a shortage of training data, posing a significant obstacle to optimizing the performance of the autonomous driving systems.

Accordingly, the use of generative models to create various, realistic images are gaining attention as a solution to the data shortage problem. Recently, the advancement of deep learning-based generative models may synthesize high-quality images, thereby enabling data augmentation techniques to be effectively utilized in various computer vision tasks.

In particular, a diffusion model has the advantages of generating high-quality images through a step-by-step process of adding and removing noise, and finely controlling specific areas. Unlike the conventional generative adversarial network (GAN), the diffusion model has recently attracted attention in the field of image generation due to their ability to train reliably and produce various outputs. In particular, conditional diffusion models, such as ControlNet, may generate images based on user-specified conditions (e.g., soiled areas), and thus, are well-suited for generating data that reflects various soiled patterns, transparency, and environmental characteristics required in the autonomous driving environments.

Therefore, there is a growing need for methods, apparatus, and computer programs for augmenting soiled data of an autonomous driving camera sensor that can efficiently generate soiled data required for an autonomous driving system using a diffusion model.

### RELATED ART DOCUMENT

### [Patent Document]

US Patent Laid-Open Publication No. 2024-0211797

### SUMMARY

An embodiment of the present disclosure is directed to providing a method, apparatus, computer program for effectively augmenting soiled data of an autonomous driving camera sensor having various patterns and characteristics in real driving environments.

In one general aspect, a method for augmenting soiled data from an autonomous driving camera sensor, performed by a computing device includes: receiving a clean image captured by an autonomous driving camera sensor and a soiled area designation image; generating a conditioned image by performing a synthesis operation on the clean image and the soiled area designation image; and generating a first sensor contamination image by inputting a text prompt specifying foreign matters and the conditioned image to a diffusion model.

In the receiving input, the soiled area designation image generated by a variational autoencoder (VAE) may be received.

In the generating of the first sensor contamination image, ControlNet architecture may be used as the diffusion model.

The method may further include generating a second sensor contamination image by applying transparency to a soiled area of the first sensor contamination image.

The generating of the second sensor contamination image may include: separating a foreign matter generation area image from the first sensor contamination image; and separating the foreign matter generation area image into a soiled area image and a clean area image.

The generating of the second sensor contamination image may further include classifying the soiled area image into one or more class areas based on brightness values of foreign matters.

The generating of the second sensor contamination image may further include performing an alpha blending operation by applying different transparency levels to each classified class area, and synthesizing a second sensor contamination image by performing an inpainting operation on a result of the alpha blending operation and the clean area image.

In the classifying into the one or more classes, the soiled area image may be classified into n class areas based on brightness threshold values (σ₁, σ₂, . . . , σₙ), and in the synthesizing of the second sensor contamination image, the alpha blending operation may be performed by applying the following Equation 1 to each classified class area.

$$\hat{I} = {\sum }_{i} r ( {I}_{s} , {σ}_{i} ) ( {α}_{i} \cdot {I}_{s} + ( 1 - {α}_{i} ) \cdot I ) \qquad [ Equation 1 ]$$

(where, Î denotes the second sensor contamination image, I denotes the clean image, Iₛ denotes the foreign matter generation area image, r(⋅,⋅) denotes a class area classification function based on the brightness value, σᵢ denotes the brightness value threshold, and αᵢ denotes an alpha value of an ith class.)

In another general aspect, an apparatus for augmenting soiled data from an autonomous driving camera sensor includes: a processor including one or more cores; and a memory, in which the processor is configured to receive a clean image captured by the autonomous driving camera sensor and a soiled area designation image, generate a conditioned image by performing a synthesis operation on the clean image and the soiled area designation image, generate a first sensor contamination image by inputting a text prompt specifying foreign matters and the conditioned image to a diffusion model, and generate a second sensor contamination image by applying transparency to a soiled area of the first sensor contamination image.

In still another general aspect, there is provided a computer program, stored on a computer-readable storage medium, including instructions that cause a computer to perform the following operations, in which the operations include: receiving a clean image captured by an autonomous driving camera sensor and a soiled area designation image generated by a variational autoencoder; generating a conditioned image by performing a synthesis operation on the clean image and the soiled area designation image; generating a first sensor contamination image by inputting a text prompt specifying foreign matters and the conditioned image to a diffusion model; and generating a second sensor contamination image by applying transparency to a soiled area of the first sensor contamination image.

### BRIEF DESCRIPTION OF THE DRAWINGS

FIG. 1 is a flowchart of a method for augmenting soiled data of an autonomous driving camera sensor according to an embodiment of the present disclosure.

FIG. 2 is a flowchart of the method for augmenting soiled data of an autonomous driving camera sensor according to an embodiment of the present disclosure.

FIG. 3 is a flowchart of a step for generating a second sensor contamination image according to an embodiment of the present disclosure.

FIG. 4 is a diagram illustrating a postprocessing method for generating a second sensor contamination image according to an embodiment of the present disclosure.

FIG. 5 is a configuration diagram of an apparatus for augmenting soiled data of an autonomous driving camera sensor according to an embodiment of the present disclosure.

FIG. 6 is a schematic diagram of a computing embodiment according to an embodiment of the present disclosure.

### DETAILED DESCRIPTION OF EMBODIMENTS

Hereinafter, the present disclosure will be described in detail with reference to the contents described in the accompanying drawings. However, the present disclosure will be not limited or restricted to exemplary the embodiments. Throughout the accompanying drawings, like reference numerals denote members performing substantially the same functions.

The object and effect of the present disclosure may be naturally understood or made clearer by the following description, and the object and effect of the present disclosure are not limited to the following description alone. Further, in describing the present disclosure, in the case in which it is decided that a detailed description of a well-known technology associated with the present disclosure may unnecessarily make the gist of the present disclosure unclear, it will be omitted.

The terms as used herein are used only in order to describe specific embodiments rather than limiting the present disclosure. Singular expressions are intended to include plural expressions unless the context clearly indicates otherwise. It will be understood that the terms “includes” or “have” used in this application, specify the presence of stated features, numerals, steps, operations, components, parts mentioned in the present disclosure, or a combination thereof, but do not preclude the presence or addition of one or more other features, numerals, steps, operations, components, parts, or a combination thereof.

Terms such as ‘first’ and ‘second’ may be used to describe various components, but these components are not to be construed as being limited to these terms. The terms are used only in order to distinguish one component from another component. For example, a first component may be named a second component, and similarly, the second component may be named the second component, without departing from the scope of the present disclosure.

Unless indicated otherwise, all the terms used in the present specification, including technical and scientific terms, have the same meanings as meanings that are generally understood by those skilled in the art to which the present disclosure pertains. Terms generally used and defined in a dictionary are to be interpreted as the same meanings with meanings within the context of the related art, and are not to be interpreted as ideal or excessively formal meanings unless clearly indicated in the present disclosure.

When interpreting a component, it is interpreted as including the error range even if there is no separate explicit description. When describing a temporal relationship, for example, when the temporal continuity is described as ‘˜after’, ‘˜following’, ‘˜next to’, ‘˜before’, etc., it also includes cases where it is not continuous, unless ‘right away’ or ‘directly’ is used.

Hereinafter, technical configurations of the present disclosure will be described in detail with reference to the accompanying drawings.

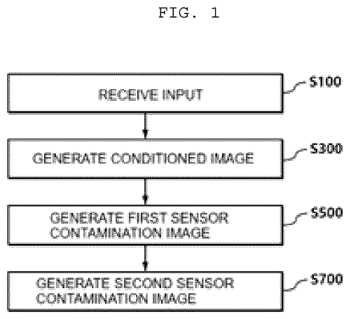

FIG. 1 is a flowchart of a method for augmenting soiled data of an autonomous driving camera sensor according to an embodiment of the present disclosure. Referring to FIG. 1, the method for augmenting soiled data of an autonomous driving camera sensor may include receiving input (S100), generating a conditioned image (S300), generating a first sensor contamination image (S500), and generating a second sensor contamination image (S700).

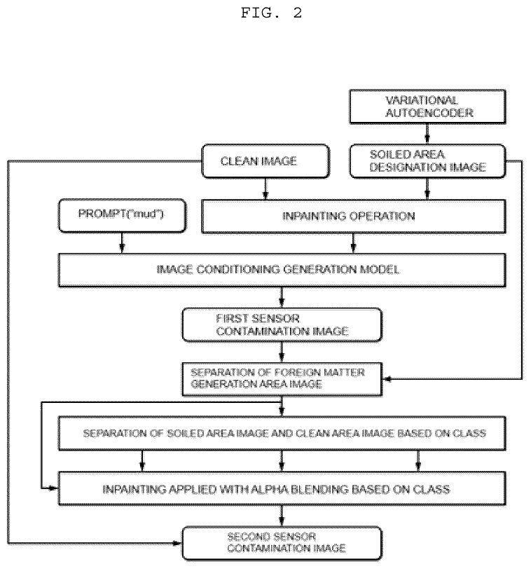

FIG. 2 is a flowchart of the method for augmenting soiled data of an autonomous driving camera sensor according to an embodiment of the present disclosure. Referring to FIG. 2, the method for augmenting soiled data of an autonomous driving camera sensor receives a soiled area designation image and a clean image generated by a variational autoencoder (VAE), generates a conditioned image through an inpainting operation, and inputs the generated conditioned image and a text prompt, such as “mud,” to a diffusion model to generate a first sensor contamination image. Next, the method for augmenting soiled data of an autonomous driving camera sensor may separate a foreign matter generation area from a first sensor contamination image and applying alpha blending that reflects transparency characteristics of foreign matters through class-based classification based on brightness values, thereby generating a final second sensor contamination image. Each step is described in detail below.

The method for augmenting soiled data of an autonomous driving camera sensor may effectively generate high-quality data with realistic soiled patterns and transparency from various camera views (front, left/right mirrors, rear, etc.), thereby significantly improving the performance of camera sensor foreign matter detection models in real-world autonomous driving environments. In particular, the method for augmenting soiled data of an autonomous driving camera sensor may significantly enhance the safety and reliability of autonomous driving systems by improving key metrics such as accuracy, precision, and mIoU.

In the receiving step (S100), a clean image captured by the autonomous driving camera sensor and a soiled area designation image may be received.

In the receiving step (S100), clean images without foreign matters captured by various camera sensors (front cameras, side mirror cameras, rear cameras, etc.) mounted on an autonomous driving vehicle may be received. The clean image may include various lighting conditions, weather conditions, and road conditions acquired from an autonomous driving environment, and may have various resolutions from a high-resolution image to a low-resolution image. In addition, the soiled area designation image designates locations of foreign matters in a specific area of the clean image, and may include information indicating distribution areas, patterns, shapes, etc., of foreign matters. The soiled area designation image may be provided in various formats, such as a binary mask form, a grayscale map, or a form containing multi-channel information, and may serve to specify an area where foreign matters will be applied during a subsequent augmentation process.

In the receiving (S100), the soiled area designation image generated by a variational autoencoder (VAE) may be received.

In the receiving step (S100), the variational autoencoder (VAE) may be utilized to enhance the diversity and realism of the soiled area designation image. The variational autoencoder is a model trained using only ground truth data for actual soiled area designations, and may effectively train a distribution of soiled patterns. In the training step, the variational autoencoder converts a ground truth image into a latent space through an encoder, and then restores the ground truth image to a similar state to the original through a decoder, thereby training key characteristics of the soiled pattern. In the inference step, the variational autoencoder may randomly sample a latent vector z from a standard normal distribution N(0,1) and generate various soiled patterns using only the trained decoder. This method may also generate new soiled patterns that were not present in the training data, thereby significantly expanding data diversity.

The soiled area designation image generated by a variational autoencoder may have the following characteristics. 1) It may represent various soiled patterns that are generated from vectors randomly sampled from a standard normal distribution; 2) It may mimic characteristics of actual foreign matters, such as irregular boundaries, various densities, and gradations; and 3) It may reflect pattern characteristics based on the type of foreign matters (e.g., mud, water droplets, and dust). The soiled area designation image generated by the variational autoencoder may be generated in various forms, ranging from simple binary masks to images containing complex patterns and gradations, thereby enabling more realistic representations of foreign matters in subsequent augmentation processes.

The soiled area designation image generated by the variational autoencoder may go beyond simply designating soiled areas, and be used as a conditioning input for a diffusion model to generate realistic soiled textures tailored to the corresponding pattern. This combination of the variational autoencoder and the diffusion model may generate infinitely various soiled patterns only with a small amount of labeled data, thereby effectively addressing the data shortage problem required for training foreign matter detection models for autonomous driving sensors.

In the step (S300) of generating the conditioned image, the conditioned image may be generated by performing the synthesis operation on the clean image and the soiled area designation image. In the step (S300) of generating the conditioned image, the conditioned image for controlling the diffusion model may be generated by combining the received clean image and soiled area designation image through a special synthesis operation.

The present disclosure implements a model structure that generates the soiled first sensor contamination image in the specific area from the clean image by utilizing the diffusion model trained on the large-capacity dataset. Among the diffusion models, the ControlNet model basically uses an approach that receives the conditioned image, such as a depth map or a canny edge image, along with text and converts the original image. However, considering the limited characteristics of the soiled data, it is realistically difficult to obtain a pair of clean images and sensor contamination images captured in the same environment. Therefore, in the step (S300) of generating the conditioned image, the soiled area designation image containing information about the designated soiled area may be utilized to generate the conditioned image.

In the step (S300) of generating the conditioned image, the inpainting operation may be utilized as the synthesis operation. In the step (S300) of generating the conditioned image, the conditioned image, which clearly distinguishes between the soiled and unsoiled areas, may be generated through the inpainting operation.

In the step (S500) of generating the first sensor contamination image, the first sensor contamination image may be generated by inputting the text prompt specifying the foreign matters and the conditioned image to the diffusion model. In the step (S500) of generating the first sensor contamination image, when generating the first sensor contamination image that is the soiled image, the foreign matters may be generated by limiting the specific area without affecting all pixels.

In the step (S500) of generating the first sensor contamination image, the soiled image may be generated in a specific area by inputting the conditioned image and the text prompt specifying the foreign matters to the diffusion model. The step (S500) of generating the first sensor contamination image is a core process of generating a conditional image, and may utilize a multi-conditional generation method that combines the text prompt and the visual conditioning.

The text prompt may specify various foreign matter types and characteristics, such as “mud,” “water droplets,” “dust,” and “snow,” and serves as a semantic guide for the diffusion model to determine which type of foreign matters to generate. The text prompt may be converted into an embedding vector through a text encoder, which may affect the first sensor contamination image generation process of the diffusion model.

In the step (S500) of generating the first sensor contamination image, the conditioned image may designate the spatial location and distribution pattern to which the foreign matters will be applied. The conditioned image is converted into the feature embedding through the encoder, which may act as a spatial control signal to guide a noise prediction process at each step of the diffusion model.

The diffusion model may include a forward process and a reverse process. In the forward process, noise is gradually added to the original image, while in the reverse process, noise is gradually removed starting from a pure noise state, thereby generating a meaningful image. In this case, the text prompt and the embedding of the conditioned image may be provided as the conditional inputs to a noise prediction network, thereby guiding the noise prediction at each step of the reverse process.

The equations for the diffusion model applied in the step (S500) of generating the first sensor contamination image are defined as Equations 2 and 3 below.

$${c}_{f} = E ( ( 1 - u ( m ) ) \cdot I ) \qquad [ Equation 2 ]$$

$$L = {E}_{{𝓏}_{0} , t , {c}_{t} , {c}_{f} , ϵ \sim N ( 0 , 1 )} {‖ ϵ - {ϵ}_{θ} ( {𝓏}_{t} , t , {c}_{t} , {c}_{f} ) ‖}_{2}^{2} \qquad [ Equation 3 ]$$

In the above Equation 2, c_{f} denotes the conditioned image, E denotes the image encoder, I denotes the input image, m denotes the soiled area designation image, and the u(⋅) function denotes binarized images for both the soiled area and the unsoiled area. In the Equation 3, □ε denotes normal distribution noise, and □ε_{θ}□ denotes noise predicted by the diffusion model. Here, the input t denotes a timestep of the diffusion model, and cₜ denotes the text prompt.

In the step (S500) of generating the first sensor contamination image, ControlNet architecture may be used as the diffusion model. The ControlNet is a model structure that may introduce an additional control mechanism to the existing diffusion model to finely control the structure and contents of the output image based on the input conditioned image.

ControlNet's core architecture is a form that freezes weights of a basic diffusion model and combines the weights with an additional network path (including a zero convolution layer) that processes the conditioned image. This additional path appropriately injects the conditioning signal into multiple layers of a U-Net architecture, thereby maintaining the influence of the conditioned image throughout the generation process.

The ControlNet architecture offers the following features and advantages of: 1) using the spatial information of the conditioned image to finely control the structure of the generated image; 2) injecting the conditioning signal into various resolution layers of the U-Net architecture to control features at various scales, from fine texture to overall distribution patterns of foreign matters; 3) training only additional control modules while reusing the weights of the existing diffusion model to achieve effective conditioning with relatively few computational resources; 4) starting with zero weights that initially have no effect, and through the zero convolution layer that is gradually trained, gradually integrating the conditioning signal without degrading the performance of the basic model; and 5) processing various types of conditioned images, such as soiled area masks, edge maps, and depth maps.

The diffusion model using the ControlNet architecture may generate the first sensor contamination image that naturally applies foreign matters only to specific areas by combining the type of foreign matters expressed in the text prompt with the distribution information of foreign matters expressed in the conditioned image. This approach may ensure both the diversity of foreign matter types and the accuracy of distribution patterns, and therefore, be ideal for data augmentation in autonomous driving sensors.

In the step (S500) of generating the first sensor contamination image, it is important to ensure that the foreign matters are applied only to specific areas after the first sensor contamination image is generated, while the remaining areas maintain the characteristics of the original clean image. Therefore, in the step (S500) of generating the first sensor contamination image, additional processing may be performed to ensure that the foreign matters are not generated in pixels outside of the specific area in the first sensor contamination image generated through the diffusion model in the inference step. Specifically, in the step (S500) of generating the first sensor contamination image, the inpainting technique to accurately isolate the soiled areas from the first sensor contamination image passed through the ControlNet and appropriately synthesize the soiled areas with the original clean image may be applied. This process may be mathematically expressed by Equation 4 below.

$$\hat{I} = ( 1 + u ( m ) ) \cdot I + u ( m ) \cdot u ( {I}_{s} ) \qquad [ Equation 4 ]$$

Here, Î denotes the second sensor contamination image, I denotes the clean image, and Iₛ denotes the foreign matter generation area image.

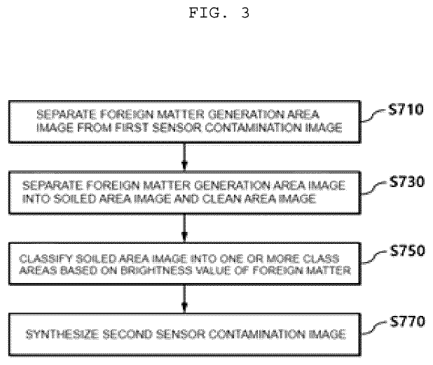

FIG. 3 is a flowchart of a step (S700) of generating the second sensor contamination image according to an embodiment of the present disclosure. Referring to FIG. 3, the step (S700) of generating the second sensor contamination image may include separating the foreign matter generation area image (S710), separating the soiled area image and the clean area image (S730), classifying the image into one or more class areas (S750), and synthesizing the second sensor contamination image (S770).

In the step (S700) of generating the second sensor contamination image, transparency may be applied to the soiled area of the first sensor contamination image to generate the second sensor contamination image. The step (S700) of generating the second sensor contamination image is a process of applying the transparency, which is important characteristics of actual foreign matters, to the first sensor contamination image to generate a more realistic soiled image. In real-world autonomous driving environments, the foreign matters on the camera sensors are not simply an opaque cover, but have characteristics of varying transparency depending on its thickness and density.

The first sensor contamination image generated in the step (S500) of generating the first sensor contamination image successfully generates the soiled area. However, this method fails to take account of transparency that is one of characteristics present in soiled patterns, making it unsuitable for augmenting actual soiled data. Therefore, it is essential to apply the image postprocessing process based on the transparency to the soiled area image separated from the first sensor contamination image, to mimic the characteristics of foreign matters.

Considering the physical characteristics of the actual foreign matters, areas where foreign matters are dense exhibit dark brightness values and low transparency due to low light transmittance. On the other hand, areas where foreign matters are thinly spread exhibit relatively high transparency. Therefore, it is reasonable to segment the class area in the soiled area based on the brightness value of the image. Accordingly, a post-processing technique that emphasizes transparency is applied. In the step (S500) of generating the first sensor contamination image, the soiled areas are extracted from the first sensor contamination image and the transparency attributes are assigned based on the brightness value distribution of the corresponding area, thereby simulating the characteristics of the actual foreign matters with various thicknesses and densities. The second sensor contamination image thus generated goes beyond the simple presence or absence of foreign matters and expresses a continuum of the transparency of foreign matters, thereby providing data more suitable for the foreign matter detection training of the autonomous driving sensor.

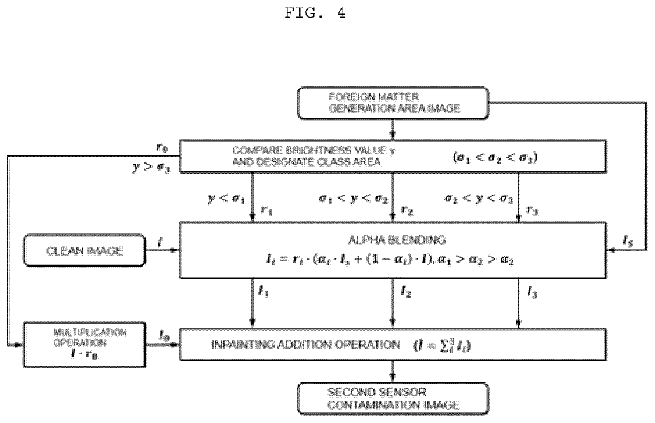

FIG. 4 is a diagram illustrating a postprocessing method for generating a second sensor contamination image according to an embodiment of the present disclosure. The postprocessing process for generating the second sensor contamination image will be described in detail below with reference to FIG. 4.

In the step (S710) of separating the foreign matter generation area image may separate the foreign matter generation area image from the first sensor contamination image. Here, the foreign matter generation area image may refer to an image obtained by separating only the soiled area from the first sensor contamination image.

The step (S710) of separating the foreign matter generation area image is a process of effectively separating only the soiled areas from the first sensor contamination image. The first sensor contamination image is an image generated through the diffusion model, and is a state in which foreign matters are applied to a specific area. In the step (S710) of separating the foreign matter generation area image, the previously used soiled area designation image may be used as reference information for accurate soiled area identification.

The step (S710) of separating the foreign matter generation area image may be implemented using various image processing techniques, including: 1) extracting an area using the soiled area designation image as a mask, 2) segmenting an area based on image characteristics such as color, texture, and brightness value, 3) identifying a soiled area using a deep learning-based segmentation model, 4) analyzing a difference value between the original clean image and the first sensor contamination image, etc.

The foreign matter generation area image Iₛ separated in the step (S710) of generating the foreign matter generation area image may serve as basic data for applying transparency characteristics in subsequent steps. The step (S710) of separating the foreign matter generation area image is a crucial step of accurately identifying the soiled area and clearly distinguishing the soiled area from the background area, ensuring the accuracy of subsequent transparency processing.

In the step (S730) of separating the foreign matter generation area image into the soiled area image and the clean area image, the foreign matter generation area image may be separated into the soiled area image and the clean area image. The foreign matter generation area image may be defined as the area of the clean image on which foreign matters have been deposited. Therefore, the soiled area image may refer to an image that separates only the foreign matters from the area, and the clean area image may refer to a clean image corresponding to the area.

In the step (S730) of separating the foreign matter generation area image into the soiled area image and the clean area image, the foreign matter generation area image may be subdivided into two components: the soiled area image and the clean area image. The step (S730) of separating the foreign matter generation area image into the soiled area image and the clean area image is a separation method that reflects the essential structure of the actual soiled image, and the foreign matter generation area may essentially be regarded as a composite structure in which a soiled layer is superimposed onto the original clean image.

The soiled area image is a layer that purely includes the characteristics of foreign matters (texture, color, pattern, etc.) and may be subject to subsequent transparency processing. On the other hand, the clean area image represents the original background of the corresponding location and may be used as the background visible beneath the foreign matters during the final synthesis process.

The step (S730) of separating the foreign matter generation area image into the soiled area image and the clean area image may be implemented through processing methods, including: 1) calculating a difference between the original clean image and the foreign matter generation area image; 2) separating the foreground (foreign matter) and background (clean area) using a layer decomposition algorithm; 3) applying an image decomposition technique that considers optical characteristics of foreign matters; and 4) extracting layers using a reference clean image.

The soiled area image and the clean area image obtained through the step (S730) of separating the foreign matter generation area image into the soiled area image and the clean area image may be used as key input data for the subsequent transparency processing and the final synthesis process.

In the step (S750) of classifying the soiled area image into one or more class areas, the soiled area image may be classified into one or more class areas based on the brightness values of foreign matters. The step (S750) of classifying the soiled area image into one or more class areas is a process of subdividing the soiled area image into multiple classes based on the brightness values of foreign matters. The step (S750) of classifying the soiled area image into one or more class areas is based on the physical characteristics that the transparency, which is important characteristics of actual foreign matters, is correlated with brightness values.

Generally, areas where foreign matters are thick and dense have low light transmittance, resulting in dark brightness values and low transparency. On the other hand, areas where foreign matters are thinly distributed have relatively bright values and high transparency. By classifying the pixels of the soiled area image into various classes based on the brightness values while reflecting these characteristics, it is possible to model changes in transparency according to the thickness and density of foreign matters.

In an embodiment, the step (S750) of classifying the soiled area image into one or more class areas may be performed based on a brightness value y and threshold values σ₁, σ₂, and σ₃, and the soiled area may be classified into four classes r₀, r₁, r₂, and r₃. Each class may be defined as r₀ (area where y>σ₃, brightest area, close to clean), r₁ (area where σ₁<y<σ₂, intermediate dark area), r₂ (area where σ₂<y<σ₃, medium dark area), and r₃ (area where y<σ₁, darkest area, area where foreign matters are the thickest). This classification method is effective in modeling the continuous transparency change of foreign matters step by step, and may express various soiled patterns and characteristics.

In the step (S750) of classifying the soiled area image into one or more class areas, the soiled area image may be classified into n class areas based on brightness threshold values σ₁, σ₂, . . . , σₙ. The step (S750) of classifying the soiled area image into one or more class areas is an approach for quantitatively and precisely modeling the transparency characteristics of foreign matters.

A threshold value σᵢ may be set in consideration of the brightness value distribution of pixels within the soiled area. This may be predefined as a fixed value or dynamically determined through image histogram analysis. Various implementations are possible depending on a threshold value setting method. The method may include: 1) equally dividing the brightness value range (0 to 255) into n sections; 2) using a specific quantile in the brightness value distribution of the soiled area pixels as the threshold value; 3) using natural cluster boundaries as the threshold value using an algorithm such as K-means; and 4) setting the threshold value based on the relationship between the optical properties of foreign matters and its transparency.

As illustrated in FIG. 4, in one embodiment, three threshold values σ₁, σ₂, and σ₃ may be used to classify into four classes, each of which may represent a specific transparency transition point. This classification is performed using a r(Iₛ, σᵢ) function, which compares the brightness values of each pixel with the threshold value to determine the class to which the pixel belongs. The classification method based on brightness threshold values may finely control the transparency processing and effectively simulate various physical characteristics of foreign matters (such as thickness, density, and distribution patterns).

In the step (S770) of synthesizing the second sensor contamination image, the alpha blending operation may be performed by applying different transparency levels to each classified class area, and the inpainting operation is performed on the result of the alpha blending operation and the clean area image to synthesize the second sensor contamination image.

The step (S770) of synthesizing the second sensor contamination image is the final synthesis process that applies differentiated transparency to previously classified soiled class areas and naturally integrates the soiled class areas with the clean area image. The step (S770) of synthesizing the second sensor contamination image is a key process of generating the final sensor contamination image that realistically reflects the transparency characteristics of foreign matters.

The alpha blending operation, which applies different transparency values α to each class area, is essential for simulating the continuous transparency changes of the soiled pattern. In this case, the transparency values are assigned based on the physical characteristics of each class. Generally, classes (areas where foreign matters are thickly distributed) with low brightness values are assigned low transparency (low α values), while classes with high brightness values are assigned high transparency (high σ value).

After the alpha blending operation, the results are integrated with the clean area image through the inpainting operation. This inpainting process ensures a natural transition between the soiled area and the unsoiled area and minimizes artifacts near the boundaries.

In the step (S770) of synthesizing the second sensor contamination image, the alpha blending may be applied to each class area r₁, r₂, and r₃ to generate intermediate results I₁, I₂, and I₃, which are then summed to produce the final image Î. In this process, the clean area r₀ may be used as it is in the original image.

In the step (S770) of synthesizing the second sensor contamination image, the alpha blending operation may be performed by applying the following Equation (1) to each classified class area.

$$\hat{I} = {\sum }_{i} r ( {I}_{s} , {σ}_{i} ) ( {α}_{i} \cdot {I}_{s} + ( 1 - {α}_{i} ) \cdot I ) \qquad [ Equation 1 ]$$

(where, Î denotes the second sensor contamination image, I denotes the clean image, Iₛ denotes the foreign matter generation area image, r(⋅,⋅) denotes a class area classification function based on the brightness value, σᵢ denotes the brightness value threshold, and αᵢ denotes an alpha value of an ith class.)

The above Equation 1 may accurately model the transparency characteristics of foreign matters and provide the flexibility to express various soiled patterns and characteristics by adjusting the number n of classes and the alpha value αᵢ of each class. In addition, the above Equation 1 may be applied on a pixel-by-pixel basis, and thus, express even subtle changes within the soiled pattern.

According to the present invention, when the number of classes is classified into 2, 3, and 4 according to the transparency, including the clean area, and the results considering the transparency was the best when classified into four classes.

The comparison of the results of training a segmentation model using a front view class, which collects only data captured by a camera installed in front of a vehicle from publicly available soiled data, with the results of applying the invention to the same model and using images generated as additional training data is shown in Table 1 below. The comparison was conducted across all camera view classes of the existing soiled data, and it was confirmed that accuracy, precision, and mIoU performance were superior.

TABLE 1

| Training data | Test data | Accuracy | Precision | mIoU |
|---|---|---|---|---|
| Data of front | Data of four | 0.897 | 0.791 | 0.679 |
| view | views (FV, | | | |
| | MVL, MVR, | | | |
| | RV)) | | | |
| Data of front | Data of four | 0.904 | 0.811 | 0.694 |
| view + | views (FV, | | | |
| generation image | MVL, MVR, | | | |
| | RV)) | | | |

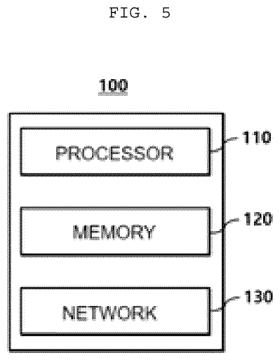

FIG. 5 is a configuration diagram of an apparatus 100 for augmenting soiled data of an autonomous driving camera sensor according to an embodiment of the present disclosure. Referring to FIG. 5, the configuration of the apparatus 100 for augmenting soiled data of an autonomous driving camera sensor illustrated is merely a simplified example. In an embodiment of the present disclosure, the apparatus 100 for augmenting soiled data of an autonomous driving camera sensor may include other components for implementing the computing environment of the apparatus 100, and only some of the disclosed components may constitute the apparatus 100.

The apparatus 100 for augmenting soiled data of an autonomous driving camera sensor may include a processor 110 including one or more cores, a memory 120, and a network 130.

The processor may be configured with one or more cores, and may include a processor for data analysis and deep learning, such as a central processing unit (CPU), a general purpose graphics processing unit (GPGPU), or a tensor processing unit (TPU) of a computing device. The processor 110 may read a computer program stored in the memory 120 and perform data processing for machine learning according to an embodiment of the present disclosure. According to an embodiment of the present disclosure, the processor 110 may perform an operation for training a neural network. The processor 110 may perform calculations for training a neural network, such as processing input data for training in deep learning (DL), extracting features from input data, calculating errors, and updating weights of a neural network using backpropagation. At least one of the CPU, GPGPU, and TPU of the processor 110 may process training of a network function. For example, the CPU and the GPGPU may together process the training of the network function and data classification using the network function. Furthermore, in an embodiment of the present disclosure, processors of multiple computing devices may be used together to process the training of the network function and the data classification using the network function. In addition, a computer program executed on a computing device according to an embodiment of the present disclosure may be a CPU, GPGPU, or TPU executable program.

The processor 110 may receive a clean image and a soiled area designation image captured by an autonomous driving camera sensor. The processor 110 may perform the receiving step (S100) described above.

The processor 110 may generate the conditioned image by performing the synthesis operation on the clean image and the soiled area designation image. The processor 110 may perform the step (S300) of generating the conditioned image described above.

The processor 110 may input the text prompt specifying the foreign matters and the conditioned image to the diffusion model to generate the first sensor contamination image. The processor 110 may perform the step (S500) of generating the first sensor contamination image described above.

The processor 110 may apply the transparency to the soiled area of the first sensor contamination image to generate the second sensor contamination image. The processor 110 may perform the step (S700) of generating the second sensor contamination image described above.

The memory 120 may store any type of information generated or determined by the processor 110 and any type of information received by the network 130.

The memory 120 may include at least one of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may also operate in connection with a web storage performing a storage function of the memory 120 on the Internet. The description of the above-described memory is merely an example, and the present disclosure is not limited thereto.

The network 130 may use any type of known wired or wireless communication system. The network 130 may receive the clean image, etc., from a related device or related system.

The network 130 may transmit and receive information, user interfaces, etc., processed by the processor 110 through communication with other terminals. For example, the network 130 may provide a user interface generated by the processor 100 to a client (e.g., a user terminal). In addition, the network 130 may receive external input from a user authorized as a client and transmit the external input to the processor 110. In this case, the processor 110 may process operations such as outputting, modifying, changing, and adding information provided through the user interface based on the user's external input received from the network 130.

Meanwhile, the apparatus 100 for augmenting soiled data of an autonomous driving camera sensor according to an embodiment of the present disclosure may include a server as a computing system that transmits and receives information through communication with the client. In this case, the client may be any type of terminal capable of accessing the server.

In an additional embodiment, the apparatus 100 for augmenting soiled data of an autonomous driving camera sensor may include any type of terminal that receives data resources generated from any server and performs additional information processing.

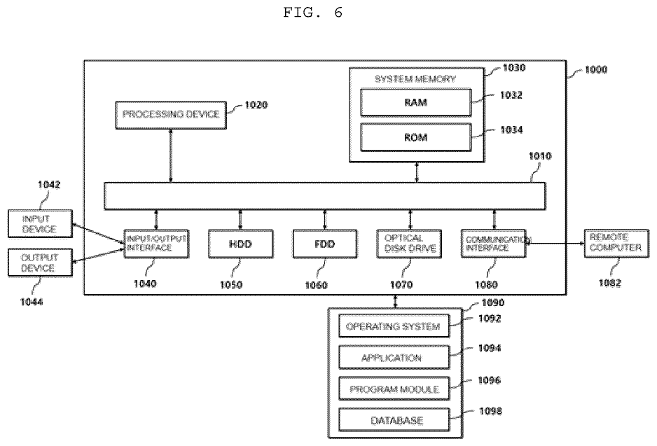

FIG. 6 is a schematic diagram of a computing embodiment according to an embodiment of the present disclosure.

Although the present disclosure has been described above as being generally implemented by a computing device, those skilled in the art will appreciate that the present disclosure may be implemented in combination with computer-executable instructions and/or other program modules that may be executed on one or more computers and/or as a combination of hardware and software.

Generally, program modules include routines, programs, components, data structures, and the like that perform specific tasks or implement specific abstract data types. Furthermore, those skilled in the art will appreciate that the methods of the present disclosure may be implemented in other computer system configurations, including single-processor or multiprocessor computer systems, minicomputers, mainframe computers, as well as personal computers, handheld computing devices, microprocessor-based or programmable consumer electronics, and the like (each of which may be operatively connected to one or more associated devices).

The embodiments described in the present disclosure may also be practiced in distributed computing environments where certain tasks are performed by remote processing devices that are linked through a communications network. In a distributed computing environment, program modules may be located in both local and remote memory storage devices.

Computers typically include a variety of computer-readable media. Any computer-readable media may be used as long as media are accessible by a computer, and the computer-readable media include both volatile and nonvolatile media, transitory and non-transitory media, removable and non-removable media. As a non-limited example, the computer-readable media may include computer-readable storage media and computer-readable transmission media. The computer-readable storage media include both volatile and nonvolatile media, transitory and non-transitory media, removable and non-removable media implemented in any method or technology for storing information such as computer-readable instructions, data structures, program modules, or other data. The computer-readable storage media include, but are not limited to, RAM, ROM, EEPROM, flash memory, or other memory technology, CD-ROMs, digital video disks (DVDs) or other optical disk storage, magnetic cassettes, magnetic tapes, magnetic disk storage, or other magnetic storage, or any other media that may be accessed by a computer and used to store the desired information.

The computer-readable transmission media typically embody computer-readable instructions, data structures, program modules, other data, etc., in a modulated data signal, such as a carrier wave or other transport mechanism, and include any information transmission media. The term “modulated data signal” means a signal that has one or more of its characteristics set or changed so as to encode information in the signal. As a non-limited example, the computer-readable transmission media include wired media, such as a wired network or direct-wired connection, and wireless media, such as acoustic, RF, infrared, or other wireless media. Any combinations of the media described above are also included within the scope of the computer-readable transmission media.

An exemplary environment for implementing various aspects of the present disclosure is illustrated, including a computer 1000. The computer 1000 includes a processing device 1020, a system memory 1030, and a system bus 1010. The system bus 1010 connects system components, including but not limited to the system memory 1030, to the processing device 1020. The processing device 1020 may be any of a variety of commercially available processors. Dual processor and other multiprocessor architecture may also be utilized as the processing device 1020.

The system bus 1010 may be any of several types of bus structures that may additionally interconnect to a memory bus, a peripheral bus, and a local bus using any of a variety of commercially available bus architectures. The system memory 1030 includes read-only memory (ROM) 1034 and random access memory (RAM) 1032. A basic input/output system (BIOS) is stored in non-volatile memory 1034, such as ROM, EPROM, or EEPROM. The BIOS includes basic routines that help transmit information between components within the computer 1000, such as during start-up. The RAM 1032 may also include high-speed RAM, such as static RAM, for caching data.

The computer 1000 also includes an internal hard disk drive (HDD) 1050 (e.g., EIDE, SATA)—the internal hard disk drive 1050 may also be configured for external use within a suitable chassis (not illustrated)—, a magnetic floppy disk drive (FDD) 1060 (e.g., for reading from or writing to removable diskettes), and an optical disk drive 1070 (e.g., for reading from or writing to a CD-ROM disk or other high-capacity optical media such as DVD). The hard disk drive 1050, the magnetic disk drive 1060, and the optical disk drive 1070 may be connected to the system bus 1010 by a hard disk drive interface, a magnetic disk drive interface, and an optical drive interface, respectively. An interface for implementing external drives includes at least one or both of a universal serial bus (USB) and IEEE 1394 interface technologies.

These drives and their associated computer-readable media provide non-volatile storage of data, data structures, computer-executable instructions, and the like. In the case of the computer 1000, the drive and media correspond to storing any data in a suitable digital format. While the description of the computer-readable media refers to HDD, removable magnetic disks, and removable optical media such as CDs or DVDs, those skilled in the art will appreciate that other types of computer-readable media, such as zip drives, magnetic cassettes, flash memory cards, and cartridges, may also be used in the exemplary operating environment, and that any such media may include computer-executable instructions for performing the methods of the present disclosure.

A number of program modules, including an operating system 1092, one or more application programs 1094, other program modules 1096, and a database 1098, may be stored in the drives and RAM 1032. All or portions of the operating system, applications, modules, and/or data may also be cached in the RAM 1032. It will be appreciated that the present disclosure may be implemented in various commercially available operating systems or combinations of the operating systems.

A user may input commands and information to the computer 1000 via one or more wired/wireless input devices 1042, such as a keyboard and a pointing device such as a mouse. Other input devices (not illustrated) may include a microphone, an IR remote control, a joystick, a game pad, a stylus pen, a touch screen, and the like. These and other input devices are often connected to the processing device 1020 via an input/output interface 1040 that is connected to the system bus 1010, but may also be connected via other interfaces, such as a parallel port, an IEEE 1394 serial port, a game port, a USB port, and an IR interface.

A monitor or other type of display device is also connected to the system bus 1010 via an interface such as a video adapter. In addition to the monitor, a computer typically includes other peripheral output devices (not illustrated), such as a speaker and a printer.

The computer 1000 may operate in a networked environment using logical connections to one or more remote computers, such as remote computer(s) 1082 via wired and/or wireless communications. The remote computer(s) 1082 may be a workstation, a computing device computer, a router, a personal computer, a portable computer, a microprocessor-based entertainment device, a peer device, or other conventional network node, and may generally include many or all of the components described for the computer 1000. A logical connection includes a wired/wireless connection to a local area network (LAN) and/or a larger network, such as a wide area network (WAN). Such LAN and WAN networking environments are common in offices and corporations, and facilitate enterprise-wide computer networks, such as intranets, all of which may be connected to worldwide computer networks, such as the Internet.

When used in a LAN networking environment, the computer 1000 is connected to a local network (not illustrated) via a wired and/or wireless communication network interface or adapter (not illustrated). The adapter (not illustrated) may facilitate the wired or wireless communication to LAN (not illustrated), and the LAN (not illustrated) may also include a wireless access point installed therein for communicating with the wireless adapter (not illustrated). When used in a WAN networking environment, the computer 1000 may include a modem (not illustrated), be connected to a communication computing device on the WAN (not illustrated), or have other means for establishing communications over the WAN (not illustrated), such as via the Internet. The modem (not illustrated), which may be internal or external and wired or wireless, is connected to the system bus 1010 via a serial port interface (not illustrated). In the networked environment, program modules described for the computer 1000, or portions thereof, may be stored in a remote memory/storage device (not illustrated). It will be appreciated that the network connections illustrated are exemplary and that other means of establishing a communications link between computers may be used.

The computer 1000 may be any wireless device or entity configured to operate via wireless communication, and may operate to communicate with, for example, a printer, a scanner, a desktop and/or portable computer, a personal digital assistant (PDA), a communication satellite, equipment or a location associated with a wirelessly detectable tag, and a telephone. This includes at least Wi-Fi and Bluetooth wireless technologies. Therefore, the communication may be a predefined structure, as in a conventional network, or may be simply an ad hoc communication between at least two devices.

Wireless Fidelity (Wi-Fi) enables connection to the Internet and other devices without wires. The Wi-Fi is a wireless technology, similar to a cellular phone, that enables such devices, for example, a computer, to transmit and receive data indoors and outdoors, that is, at any location within a coverage area of a base station. The Wi-Fi network uses a wireless technology called IEEE 802.11 (a, b, g, etc.) to provide a secure, reliable, and high-speed wireless connection. The Wi-Fi may be used to connect computers to each other, the Internet, and wired networks (using IEEE 802.3 or Ethernet). The Wi-Fi network may operate in the unlicensed 2.4 and 5 GHz radio bands, at data rates of, for example, 11 Mbps (802.11a) or 54 Mbps (802.11b), or in products that include both bands (dual-band).

Those skilled in the art will understand that information and signals may be represented using any of a variety of different technologies and techniques. For example, data, instructions, commands, information, signals, bits, symbols, and chips referenced in the above description may be represented by voltages, currents, electromagnetic waves, magnetic fields or particles, optical fields or particles, or any combination thereof.

Those skilled in the art will appreciate that the various exemplary logical blocks, modules, processors, means, circuits, and model steps described in connection with the embodiments disclosed herein may be implemented as electronic hardware, various forms of programs or design codes (for convenience, referred to as software herein), or a combination of both. To clearly illustrate this interchangeability of hardware and software, various exemplary components, blocks, modules, circuits, and steps have been generally described above in terms of their functionality. Whether such functionality is implemented as hardware or software depends upon particular applications and design constraints imposed on the overall system. Those skilled in the art may implement the described functionality in varying ways for each particular application, but such implementation decisions should not be interpreted as causing a departure from the scope of the present disclosure.

Various embodiments described herein may be implemented as methods, apparatuses, or articles of manufacture using standard programming and/or engineering techniques. The term “article of manufacture” includes computer programs, carriers, or media accessible from any computer-readable storage device. For example, the computer-readable storage media include, but are not limited to, magnetic storage devices (e.g., hard disks, floppy disks, magnetic strips, etc.), optical disks (e.g., CDs, DVDs, etc.), smart cards, and flash memory devices (e.g., EEPROMs, cards, sticks, key drives, etc.). In addition, various storage media presented herein include one or more devices and/or other machine-readable media for storing information.

It is to be understood that the specific order or hierarchical structure of steps in the presented processes is merely an example of exemplary approaches. It is to be understood that the specific order or hierarchical structure of steps in the processes may be rearranged based on design priorities within the scope of the present disclosure The accompanying method claims present elements of various steps in a sample order, but are not intended to be limited to the specific order or hierarchical structure presented. According to the present disclosure, by combining the diffusion model with the variational autoencoder and applying the alpha blending technique that takes account of the transparency characteristics of foreign matters to effectively augment the high-quality soiled data across various autonomous driving environments and camera views, it is possible to ensure the safety and reliability of autonomous driving systems by enhancing the accuracy, precision, and mIoU performance of the foreign matter detection model of the camera sensor.

The description of the presented embodiments is provided to enable those skilled in the art to make or use the present disclosure. Various modifications to these embodiments will be readily apparent to those skilled in the art, and the generic principles defined herein may be applied to other embodiments without departing from the scope of the present disclosure. Therefore, the present disclosure is not limited to the embodiments set forth herein, but is to be construed in the broadest scope consistent with the principles and novel features disclosed herein.

The embodiment of the present disclosure described above is not implemented only through the apparatus and method, and may be implemented through a program for realizing a function corresponding to the configuration of the embodiment of the present disclosure or a recording medium in which the program is recorded. Such recording media may be executed not only on servers but also on user terminals.

Although embodiments of the present disclosure have been described in detail hereinabove, the scope of the present disclosure is not limited thereto, but may include several modifications and alterations made by those skilled in the art using a basic concept of the present disclosure as defined in the claims.

What is claimed is:

1. A method for augmenting soiled data from an autonomous driving camera sensor, performed by a computing device, comprising:
receiving a clean image captured by an autonomous driving camera sensor and a soiled area designation image;
generating a conditioned image by performing a synthesis operation on the clean image and the soiled area designation image; and
generating a first sensor contamination image by inputting a text prompt specifying foreign matters and the conditioned image to a diffusion model.

2. The method of claim 1, wherein, in the receiving, the soiled area designation image generated by a variational autoencoder (VAE) is received.

3. The method of claim 1, wherein, in the generating of the first sensor contamination image, a ControlNet architecture is used as the diffusion model.

4. The method of claim 1, further comprising:
generating a second sensor contamination image by applying transparency to a soiled area of the first sensor contamination image.

5. The method of claim 4, wherein the generating of the second sensor contamination image includes:
separating a foreign matter generation area image from the first sensor contamination image; and
separating the foreign matter generation area image into a soiled area image and a clean area image.

6. The method of claim 5, wherein the generating of the second sensor contamination image further includes classifying the soiled area image into one or more class areas based on a brightness value of the foreign matters.

7. The method of claim 6, wherein the generating of the second sensor contamination image further includes performing an alpha blending operation by applying different transparency levels to each classified class area, and synthesizing a second sensor contamination image by performing an inpainting operation on a result of the alpha blending operation and the clean area image.

8. The method of claim 7, wherein, in the classifying into the one or more classes, the soiled area image is classified into n class areas based on brightness value thresholds (σ₁, σ₂, . . . , σₙ), and
in the synthesizing of the second sensor contamination image, the alpha blending operation is performed by applying the following Equation 1 to each classified class area
$$\hat{I} = {\sum }_{i} r ( {I}_{s} , {σ}_{i} ) ( {α}_{i} \cdot {I}_{s} + ( 1 - {α}_{i} ) \cdot I ) \qquad [ Equation 1 ]$$
(where, Î denotes the second sensor contamination image, I denotes the clean image, Iₛ denotes the foreign matter generation area image, r(⋅,⋅) denotes a class area classification function based on the brightness value, σᵢ denotes the brightness value threshold, and σᵢ denotes an alpha value of an ith class.)

9. An apparatus for augmenting soiled data from an autonomous driving camera sensor, comprising:
a processor including one or more cores; and
a memory,
wherein the processor is configured to receive a clean image captured by the autonomous driving camera sensor and a soiled area designation image,
generate a conditioned image by performing a synthesis operation on the clean image and the soiled area designation image,
generate a first sensor contamination image by inputting a text prompt specifying foreign matters and the conditioned image to a diffusion model, and
generate a second sensor contamination image by applying transparency to a soiled area of the first sensor contamination image.

10. A computer program, stored on a computer-readable storage medium, including instructions that cause a computer to perform the following operations, wherein the operations include:
receiving a clean image captured by an autonomous driving camera sensor and a soiled area designation image generated by a variational autoencoder;
generating a conditioned image by performing a synthesis operation on the clean image and the soiled area designation image;
generating a first sensor contamination image by inputting a text prompt specifying foreign matters and the conditioned image to a diffusion model, and
generating a second sensor contamination image by applying transparency to a soiled area of the first sensor contamination image.
